(19) United States
(12) Patent Application Publication
(10) Pub. No.: US 2024/0037812 A1
(43) Pub. Date: Feb. 1, 2024

(54) MODIFYING STABLE DIFFUSION TO PRODUCE IMAGES WITH BACKGROUND ELIMINATED

(71) Applicant: Sony Interactive Entertainment LLC, San Mateo, CA (US)

(72) Inventor: Sophia Zalewski, San Mateo, CA (US)

(21) Appl. No.: 18/483,218

(22) Filed: Oct. 9, 2023

(51) Int. Cl. G06T 11/00; G06T 3/60; G06T 7/194; G06V 10/56; H04N 5/272

(52) U.S. Cl. CPC G06T 11/001; G06T 3/60; G06T 7/194; G06V 10/56; H04N 5/272; G06T 2207/10024

(57) ABSTRACT

Techniques are described for guiding stable diffusion to produce images with a contrasting foreground/background. Po stprocessing is implemented using segmentation and chromakeying to remove the background. These techniques extract an alpha channel in generated images to force stable diffusion to generate output with a background in a specified color, which is then removed from the image in output post-processing. Present techniques leverage the img2img inpainting pipeline with a noise mask that covers the image edges, applying noise (and generating content) only in the center of the image, thereby forcing a strong background/foreground distinction.

### BACKGROUND ELIMINATED

### Field

The present application relates to technically inventive, non-routine solutions that are necessarily rooted in computer technology and that produce concrete technical improvements, and more specifically to using generative networks to produce images with backgrounds removed/masked out.

### Background

Generative AI is a general term that refers to a type of neural network such as a large language model (LLM) such as a generative pre-trained transformer (GPTT) that can generate comparatively complex output based on comparatively terse input. An example of a LLM from the multi-domain realm is stable diffusion, which employs a series of neural networks to generate images from one or a few input words describing the desired image. As understood herein, improvements to stable diffusion are possible.

### SUMMARY

As understood herein and with more particularity, stable diffusion (SD) is unable to generate graphics with an alpha channel, which is required for graphic assets related to, e.g., computer simulations such as computer games. “Alpha channel” refers to a fourth channel besides video reg-green-blue (RGB) channels that represents the degree of transparency of a pixel. For example, graphics with an alpha channel may be required for icons and logos. Thus, there is a need to produce emblems from a given text prompt and color with their backgrounds removed so that the output images aren't square images.

Accordingly, an apparatus includes at least one processor assembly configured to modify a stable diffusion (SD) model to generate, from a first text prompt, a first image having red, green, blue, and alpha (RGBA) channels, and responsive to the first text prompt, output the first image.

In some embodiments the alpha channel represents a transparent or solid-colored background around an image of an object.

In example implementations the processor assembly can be configured to modify a noise distribution of the SD model to enable the SD model to output centered objects with low-variance backgrounds, and tune a U-Net of the SD model to allow the SD model to recognize the noise distribution modified to output centered objects with low-variance backgrounds.

In examples, the processor assembly may be configured to train a decoder of the SD model to output RGBA images using the U-Net.

In some example embodiments the processor assembly can be configured to modify the noise distribution at least in part by establishing a first noise profile in an inner circle of latents, and establishing a second noise profile outside the inner circle. The first noise profile may be uniformly random noise and the second noise profile may be offset noise that enables the SD model to learn to change a zero-frequency of the component freely.

In implementations, the processor assembly may be configured to tune the U-net at least in part by executing a tuning method on plural images with plain white backgrounds and respective corresponding text prompts followed by keywords “no background” using the noise distribution to train the SD model to produce centered foreground images with plain-colored backgrounds. The tuning method may include Low Rank Adaptation (LoRA).

In examples discussed in detail below, the processor assembly can be configured to train the decoder to output RGBA images at least in part by training the decoder to predict the alpha channel from an image with a plain-colored, low variance background output by the U-net. Moreover, the processor assembly may be configured to train the decoder to predict the alpha channel at least in part by modifying a variational autoencoder (VAE) portion of the decoder to output a fourth channel encoding alpha information, while not training an encoder of the SD model during training of the decoder, so that only the decoder is modified and a learned latent distribution remains unchanged such that the SD model predicts the fourth channel of an image based on a latent representation of the image.

In such examples the processor assembly can be configured to train the decoder to output RGBA images using a dataset of plural RGBA images with transparent backgrounds and versions of the plural images generated by applying one or more of random flips, rotations, zooms, and color augmentations of the plural images. Additionally, the processor assembly may be configured to transform at least some of the RGBA images in the dataset into respective RGB images by replacing background in the some of the RGBA images with randomly generated, low-variance backgrounds and input the respective RGB images into the decoder to cause the decoder to predict corresponding RGBA image. Still further, the processor assembly can be configured to replace transparent pixels in the at least some of the RGBA images with a random-colored background image to convert the at least some of the RGBA images back to respective images in RGB space, and determine mean squared error (MSE) loss for the respective images in RGB space such that SD model weights only visible pixels as important for alpha channel prediction.

In another aspect, a method includes extracting an alpha channel in images generated by a stable diffusion (SD) model to force the SD model to generate output images with respective backgrounds in a specified color including transparent, and removing the backgrounds in output post-processing at least in part by implementing a noise mask that covers and/or removes edges of the respective images, applying noise and generating content only in the center of the respective images.

In another aspect, an apparatus includes at least one computer medium that is not a transitory signal and that in turn includes instructions executable by at least one processor assembly to modify at least one decoder of at least one stable diffusion (SD) model to generate images having red, green, and blue (RGB) data and data indicating transparency. The instructions are executable to, responsive to a text prompt input to the SD model, receive from the SD model at least one image having RGB data and data indicating transparency.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates example output images of a SD model;

FIG. 3 illustrates example overall logic in example flow chart format;

FIG. 4 illustrates and example SD model pipeline;

FIG. 5 illustrates example logic in example flow chart format for training a network;

FIG. 6 illustrates an example noise distribution with two noise profiles;

FIG. 7 illustrates example logic in example flow chart format for tuning a U-net of the SD model;

FIG. 8 illustrates example logic in example flow chart format for training a SD model decoder to output RGBA images;

FIG. 9 illustrates additional example logic in example flow chart format for training a SD model decoder to output RGBA images;

FIG. 10 illustrates a training pipeline for customizing a loss function for RGBA images; and

FIG. 11 illustrates example logic in example flow chart format consistent with FIG. 10.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

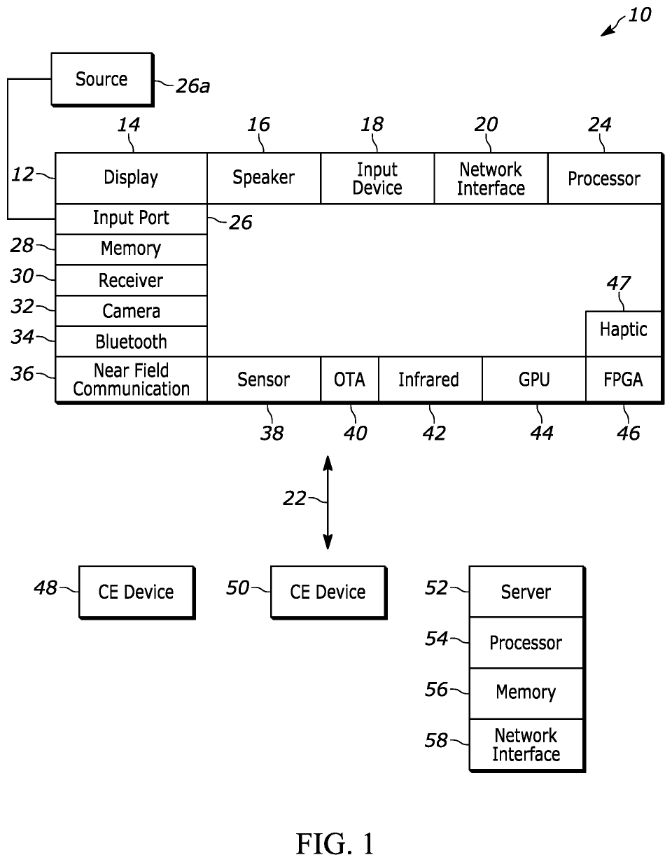

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as generative pre-trained transformers (GPTT) and stable diffusion (SD) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

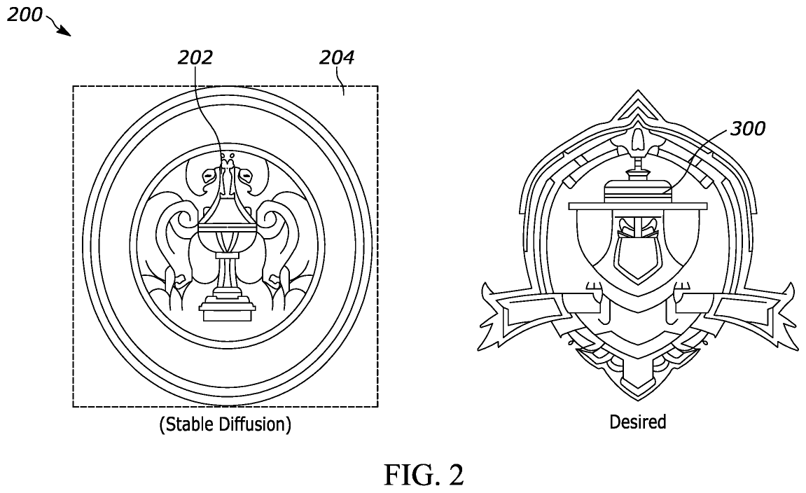

Now refer to FIG. 2. A SD model unmodified according to present principles outputs an image 200 in response to a text prompt that includes the image 202 identified by the prompt and a generally square background 204 surrounding the image, which is undesirable in certain use cases. However, modifying the SD model as set forth herein to include an alpha channel in output images can produce an image 300 with no surrounding background.

One solution to the alpha channel dilemma would be to modify the encoder and decoder structure of the pipeline to produce a fourth channel that would encode alpha (transparency) information about images. However, this would mean that the U-Net would have to completely relearn the 4×64×64 latent distribution of images to understand how to encode alpha—requiring retraining all three networks (encoder, U-Net, decoder) on billions of images. This full-scale retraining is extremely resource-intensive.

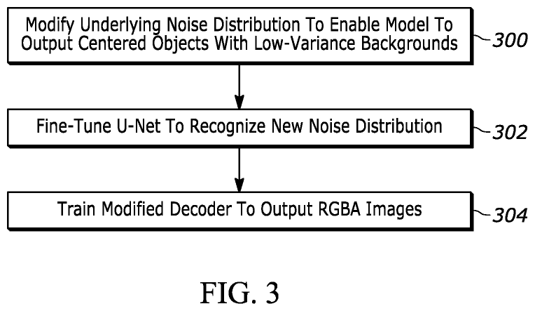

Accordingly, present principles begin at state 300 of FIG. 3 to first modify the underlying noise distribution of the model to enable it to output centered objects with low-variance backgrounds. Moving to state 302, the U-Net of the SD model is tuned to allow the pipeline to recognize this new noise distribution from state 300. Then, at state 304 the decoder is modified by training to output RGBA images.

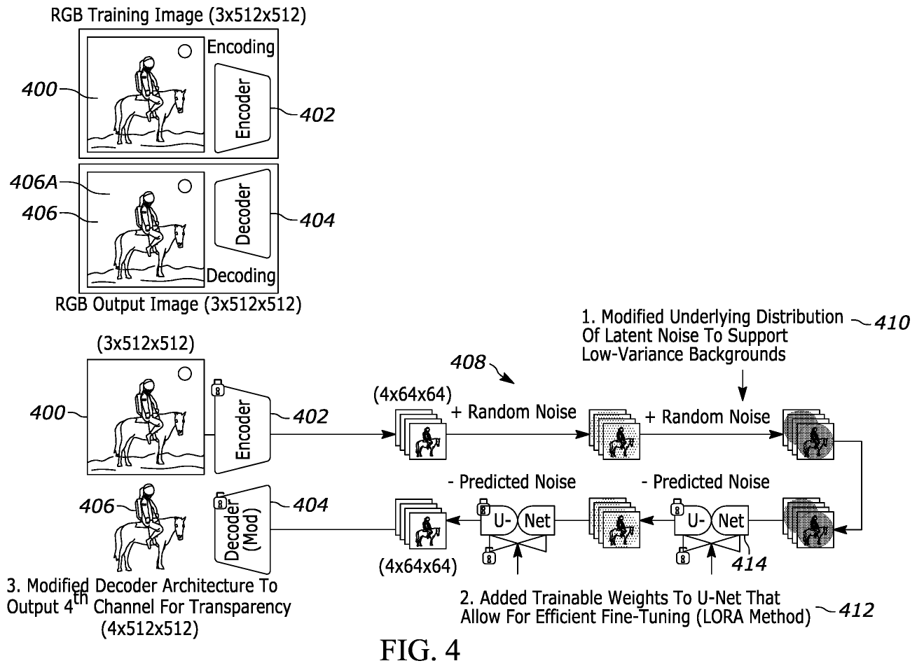

FIG. 4 illustrates how the states in FIG. 3 relate to a SD model pipeline in which an input image 400 is input to an encoder 402 and is decoded by a decoder 404 (after noise operations) to produce an output image 406 of four channels (RGBA), 512×512 pixels and no background compared to an output image 406A of only three channels (RGB) with 512×512 pixels that would be produced absent present principles.

As shown in FIG. 4, a processing pipeline 408 adds random noise to the input image in plural stages. The first modification as indicated at 410 (state 300 in FIG. 3) is modify the underlying distribution of latent noise as discussed further herein to support low-variance backgrounds. The second modification as indicated at state 412 (state 302 in FIG. 3) is to add trainable weights to the U-net 414 to tune the U-net to allow for efficient fine-tuning in producing a fourth channel (i.e., RGBA images). The third modification (state 304 in FIG. 3) is to modify the decoder architecture to output a fourth channel in its images (i.e., to output RGBA images) to contain data indicating that the background of the image is transparent.

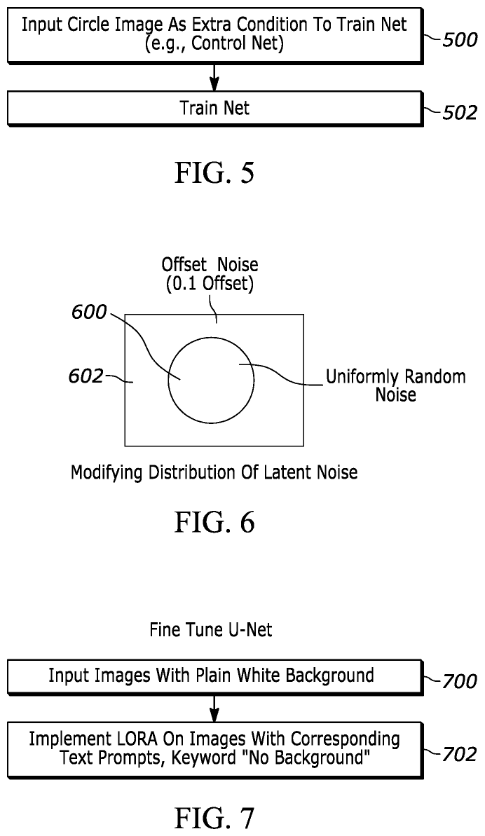

Refer to FIGS. 5 and 6, which illustrate modifying the underlying noise distribution (state 300 in FIG. 3). By default, Stable Diffusion generates images from uniformly random values of initial noise, which causes the resulting output images to consistently exhibit variance somewhat evenly throughout the entire image. However, as understood herein this prevents the model from being able to generate the homogeneous pixel values necessary to create a proper transparent or solid-colored background.

Commencing at state 500 in FIG. 5, a circle image is input as an extra condition to train a network such as the Control New of an SD model. The net is trained at state 502.

FIG. 6 illustrates that, to enable the diffusion pipeline to produce centered, high variance foreground images with homogeneous backgrounds—a defining feature of RGBA images with transparent backgrounds—the initial noise distribution to produce uniformly random noise in the innermost circle 600 of the latents, and offset noise (described here) in the remainder 602 of the space. Offset noise enables the model to learn to change the zero-frequency of the component freely, because that component is now being randomized about ten times faster than the base distribution. Using an example-only value of 0.1 in the example non-limiting code below may be small enough so as not to dominate too much of the model's existing behavior, but large enough to be effective:

noise=torch.randn_like(latents)+0.1*torch.randn(latents.shape[0], latents.shape[1], 1, 1)

This allows the pipeline to generate distinct foregrounds with homogeneous backgrounds that it will eventually learn to identify as “transparent”.

FIG. 7 illustrates details of state 302 of FIG. 3, namely, fine tuning the U-Net to understand the new noise distribution. After modifying the noise distribution of the diffusion pipeline, the next step was facilitating a finetune to allow the model to better learn this new distribution. In non-limiting embodiments Low Rank Adaptation (LoRA) may be used for this purpose.

Plural images (e.g., about one hundred) with plain white backgrounds are input at state 700 in FIG. 7 and LoRA run on this dataset at state 702 with the images and their corresponding text prompts followed by the keywords “no background” using the new noise distribution. This enables Stable Diffusion to understand the new noise pattern and produce centered foreground images with plain-colored backgrounds as desired after only around three hundred steps of training.

Turn now to the remaining figures for details of state 304 in FIG. 3 for training a 4-channel decoder to output RGBA images. The decoder is trained to predict the alpha channel from an image with a plain-colored, low variance background, which the diffusion pipeline is now capable of producing.

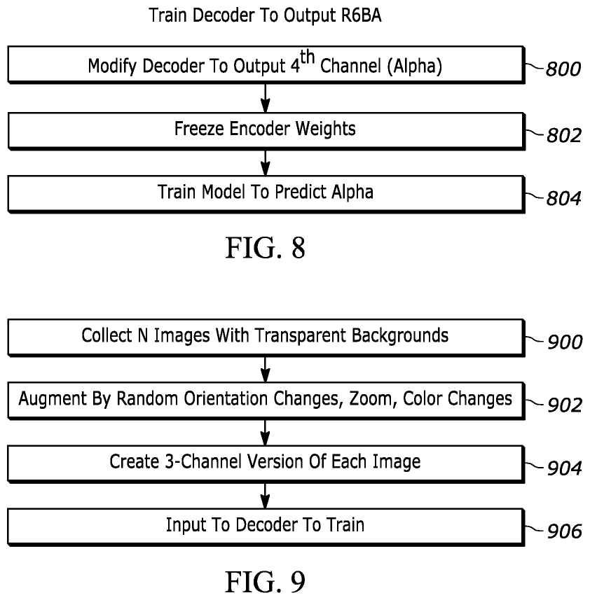

Commencing at state 800 in FIG. 8, a variational autoencoder (VAE) portion of the decoder is modified to output a fourth channel encoding alpha information (see code below). State 802 indicates that this is done without changing the encoder, e.g., by “freezing” the encoder weights so that during training, only the decoder is modified and the learned latent distribution remains unchanged. The model is then trained at state 804 to essentially “predict” the alpha channel of an image based on its latent representation.

#Load Stable Diffusion's standard pretrained Autoencoder,but modified to output a 4th channel

```
  vae = AutoencoderKL.from_pretrained( “runwayml/stable-diffusion-
  v1-5”,
subfolder=“vae”, out_channels=4, low_cpu_mem_usage=False,
ignore_mismatched_sizes=True).to(“cuda”)
```

#Only train the decoder weights, leave the encoder untouched to maintain the learned latent distribution

optimizer =torch.optim.Adam(vae.decoder.parametrs( ),1r=1e-4)

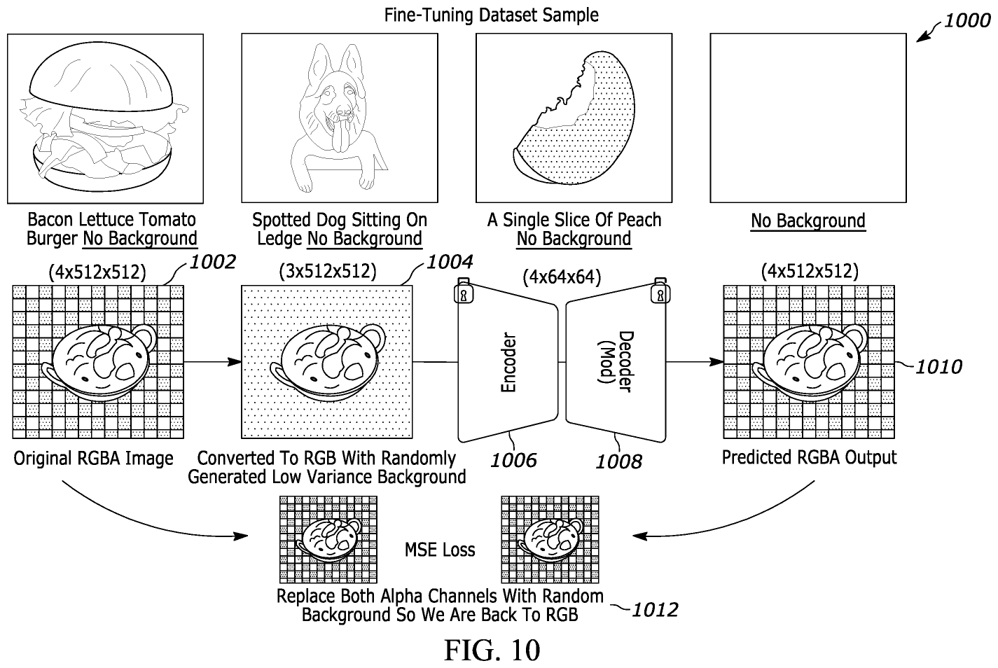

To formulate a dataset for this task, a training set (e.g., one hundred) images with transparent backgrounds are collected at state 900 in FIG. 9, shown at 1000 in FIG. 10. The images are augmented at state 902 into a set of around two thousand images (the precise number of images may vary) by applying random flips, rotations, zooms, and color augmentations.

Each RGBA training image (1002 in FIG. 10) is then transformed into a 3-channel (RGB) version of itself at state 904 and indicated at 1004 in FIG. 10, wherein the image's background is replaced with a randomly generated, low-variance background to simulate possible outputs from the diffusion pipeline as illustrated further in FIG. 10. The three channel images serve as the input to an encode 1006 and thence to a modified VAE at state 906 to train the decoder 1008 to predict corresponding RGBA images (1010 in FIG. 10) from which the input RGB images were derived.

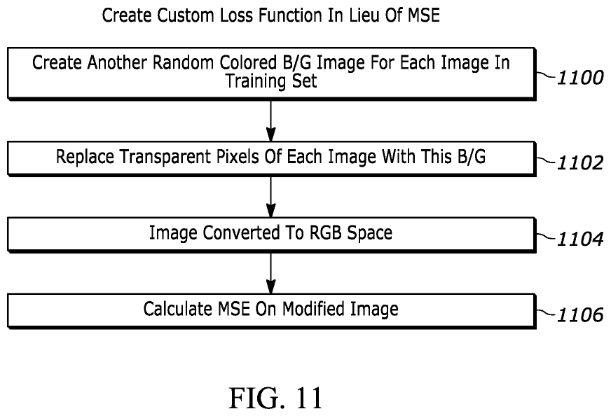

FIGS. 10 and 11 illustrate that instead of using standard mean squared error (MSE) loss between the target RGBA image and output RGBA images, which could equally weight visible and non-visible pixel values, a custom loss function is created that more closely corresponds to the visual similarity between semi-transparent images. The custom loss entails creating another random colored background image at state 1100 in FIG. 11, and “replacing” each image's transparent pixels with this background at state 1102 to convert the images back to the RGB space at state 1104, wherein MSE loss is then calculated at state 1106. This allows the model to just weight visible pixels as “import” in the final reconstruction, and produce better results during decoding and alpha channel prediction.

Finally, after fine-tuning on modified noise and training an augmented decoder to create alpha channel predictions from latents, the new U-Net and decoder to are combined to finalize the modified pipeline. Example code is below.

```
  from diffusers import StableDiffusionPipeline
  # Load the Stable Diffusion Pipeline
  model_id = “runwayml/stable-diffusion-v1-5”
  pipe = StableDiffusionPipeline.from_pretrained
  (model_id, safety_checker=None)
  # Load fine-tuned U-Net (LORA)
  pipe.unet.load_attn_procs(“path_to_lora_finetune”)
  # Load custom decoder (3-to-4)
  vae = AutoencoderKL.from_pretrained(model_id, subfolder=“vae”,
  out_channels=4,
low_cpu_mem_usage=False, ignore_mismatched_sizes=True).to(“cuda”)
  vae.load_state_dict(torch.load(“path_to_trained_autoencoder”))
  pipe. vae = vae
  pipe = pipe.to(“cuda”)
```

Running inference on this modified pipeline is able to output RGBA images without any extra post-processing.

In addition to description above, present techniques envision creating a guidance image by embedding a colored circle into a solid-colored background image, and a corresponding noise mask is created by embedding a slightly larger white circle into an all-black background. In the circle of the image, more noise is added than outside the circle, which may be thought of as a circle of latents. The input image and noise mask are passed into the Stable Diffusion inpainting pipeline, which creates output images where the background matches the (e.g., green) input background, and the foreground content is similar to the input color. To remove the color background, a binary alpha channel mask is created with ones where the output image values are within a certain RGB distance threshold of the background color, and zeroes otherwise. The alpha channel is then stacked onto the RGB output image to create an RGBA output image where the color background is now fully transparent.

The noise mask diameter may be varied. As long as the noise mask covered at least all of the centered color patch, the output image is able to form non-circle shapes. The exact ratio of color patch diameter to noise diameter does not influence the output image shape significantly; however, larger ratios of mask circle diameter to image color diameter allow the output image to vary slightly more from the circle input shape.

The noise mask shape also may be varied from rectangle to circle to other shapes without unduly affecting the output image. The portion of the colored circle that is covered by this mask (can have noise applied to it) is a stronger indicator of the output image quality.

Noise masks that covered a larger portion of the image background (and color patch), but still did not add noise to the entire background produce higher quality output images. Masks with “holes” in the center (not applying noise to a small section of the color patch) produce output that is a closer color match to the input patch color.

Color patch shape also may be varied to influence the output shape.

Further, by applying noise to the entire image (img2img without inpainting masking), the output image's background does not adhere to the original, green-screened background color, and is also less of a solid-color block (increased shadows and gradients in the background), leaving background erasing slightly more challenging. As long as any part of the color background in the input image is barred from noise addition, the output tends to have a solid-colored background in an almost exact color-match to the original image.

Accordingly, any section of an image that noise is not added to (for example, noise mask covering part of background or foreground image) forces the output image to almost perfectly match the colors of those corresponding areas in the input image. Using noise masks that don't add noise to part of the background forces the output background to more closely match the original background color. Noise masks with a center hole that don't add noise to part of the color patch force the output images to more closely follow the color scheme of the color patch after post-processing. More diverse emblem shapes can be achieved by having a large noise mask to color patch diameter ratio.

Thus, an alpha channel is extracted in images generated by a stable diffusion (SD) model to force the SD model to generate output images with respective backgrounds in a specified color, and the backgrounds are removed in post-processing by implementing a noise mask that covers and/or removes edges of the respective images, applying noise and generating content only in the center of the respective images.

While particular techniques are herein shown and described in detail, it is to be understood that the subject matter which is encompassed by the present application is limited only by the claims.

What is claimed is:

1. An apparatus comprising:
at least one processor assembly configured to:
modify a stable diffusion (SD) model to generate, from a first text prompt, a first image having red, green, blue, and alpha (RGBA) channels; and
responsive to the first text prompt, output the first image.

2. The apparatus of claim 1, wherein the alpha channel represents a transparent or solid-colored background around an image of an object.

3. The apparatus of claim 1, wherein the processor assembly is configured to:
modify a noise distribution of the SD model to enable the SD model to output centered objects with low-variance backgrounds;
tune a U-Net of the SD model to allow the SD model to recognize the noise distribution modified to output centered objects with low-variance backgrounds.

4. The apparatus of claim 3, wherein the processor assembly is configured to:
train a decoder of the SD model to output RGBA images using the U-Net.

5. The apparatus of claim 3, wherein the processor assembly is configured to modify the noise distribution at least in part by:
establishing a first noise profile in an inner circle of latents; and
establishing a second noise profile outside the inner circle.

6. The apparatus of claim 5, wherein the first noise profile is uniformly random noise and the second noise profile is offset noise that enables the SD model to learn to change a zero-frequency of the component.

7. The apparatus of claim 3, wherein the processor assembly is configured to tune the U-net at least in part by:
executing a tuning method on plural images with plain white backgrounds and respective corresponding text prompts followed by keywords “no background” using the noise distribution to train the SD model to produce centered foreground images with plain-colored backgrounds.

8. The apparatus of claim 7, wherein the tuning method comprises Low Rank Adaptation (LoRA).

9. The apparatus of claim 4, wherein the processor assembly is configured to train the decoder to output RGBA images at least in part by:
training the decoder to predict the alpha channel from an image with a plain-colored, low variance background output by the U-net.

10. The apparatus of claim 9, wherein the processor assembly is configured to train the decoder to predict the alpha channel at least in part by:
modifying a variational autoencoder (VAE) portion of the decoder to output a fourth channel encoding alpha information;
not training an encoder of the SD model during training of the decoder, so that only the decoder is modified and a learned latent distribution remains unchanged such that the SD model predicts the fourth channel of an image based on a latent representation of the image.

11. The apparatus of claim 9, wherein the processor assembly is configured to train the decoder to output RGBA images using a dataset comprising plural RGBA images with transparent backgrounds and versions of the plural images generated by applying one or more of random flips, rotations, zooms, and color augmentations of the plural images.

12. The apparatus of claim 11, wherein the processor assembly is configured to:
transform at least some of the RGBA images in the dataset into respective RGB images by replacing background in the some of the RGBA images with randomly generated, low-variance backgrounds;
input the respective RGB images into the decoder to cause the decoder to predict corresponding RGBA image.

13. The apparatus of claim 11, wherein the processor assembly is configured to:
replace transparent pixels in the at least some of the RGBA images with a random-colored background image to convert the at least some of the RGBA images back to respective images in RGB space; and
determine mean squared error (MSE) loss for the respective images in RGB space such that SD model weights only visible pixels as important for alpha channel prediction.

14. A method comprising:
extracting an alpha channel in images generated by a stable diffusion (SD) model to force the SD model to generate output images with respective backgrounds in a specified color; and
removing the backgrounds in output post-processing at least in part by implementing a noise mask that covers and/or removes edges of the respective images, applying noise and generating content only in the center of the respective images.

15. An apparatus comprising:
at least one computer medium that is not a transitory signal and that comprises instructions executable by at least one processor assembly to:
modify at least one decoder of at least one stable diffusion (SD) model to generate images having red, green, and blue (RGB) data and data indicating transparency; and
responsive to a text prompt input to the SD model, receive from the SD model at least one image having RGB data and data indicating transparency.

16. The apparatus of claim 15, wherein the data indicating transparency indicates a transparent background around an image of an object.

17. The apparatus of claim 15, wherein the instructions are executable to train the decoder:
modifying a variational autoencoder (VAE) portion of the decoder to output a fourth channel encoding alpha information.

18. The apparatus of claim 15, wherein the instructions are executable to train the decoder using a dataset comprising plural RGBA images with transparent backgrounds and versions of the plural images generated by applying one or more of random flips, rotations, zooms, and color augmentations of the plural images.

19. The apparatus of claim 18, wherein the instructions are executable to:
transform at least some of the RGBA images in the dataset into respective RGB images by replacing background in the some of the RGBA images with randomly generated, low-variance backgrounds;
input the respective RGB images into the decoder to cause the decoder to predict corresponding RGBA image.

18. The apparatus of claim 18, wherein the instructions are executable to:
replace transparent pixels in the at least some of the RGBA images with a random-colored background image to convert the at least some of the RGBA images back to respective images in RGB space; and
determine mean squared error (MSE) loss for the respective images in RGB space such that SD model weights only visible pixels as important for alpha channel prediction.
